(19) United States
(12) Patent Application Publication
(10) Pub. No.: US 2002/0024683 A1
(43) Pub. Date: Feb. 28, 2002

(54) DOCUMENT-ARCHIVING METHOD

(76) Inventor: ADALBERT GUBO, MAINZ (DE)

Correspondence Address: COLLARD & ROE, 1077 NORTHERN BOULEVARD, ROSLYN, NY, 11576

(21) Appl. No.: 08/981,995

(22) PCT Filed: Jul. 1, 1996
(86) PCT No.: PCT/DE96/01172

(30) Foreign Application Priority Data
Jul. 4, 1995 (DE) 195 24 398.6

(51) Int. Cl. B41B 1/00

(52) U.S. Cl. 358/1.17

(57) ABSTRACT

The invention concerns a documentarchiving method which does not use a scanner. To this end, a recording and reproduction circuit controls the memory of a personal computer by means of the last printed imageproducing output signals of a running printer and files in the memory an identical binary image of the document to be printed. This image is recorded on a nonerasable data carrier (e.g. a CDROM) for permanent storage.

It is known that the copy of a document or of a drawing is produced by making a photostatic copy. The methods used in this connection are mainly:

(a) Filming, e.g. microfilm

(b) Screened electronic copy by a copier or scanner, e.g. as defined by JP 2-246469 (A).

The electronic copy produced by a scanner is stored in a memory so as to be available for repeated printouts. As opposed to the above, the invention is based on the problem of archiving a document without renewed acquisition.

Both methods are based on acquisition of the original by mechanically passing it through an optical lens system. The limitations resulting from this method are, on the one hand, lack of speed of such systems, and possible falsification due to soiling or damage of the lens system, on the other hand.

The invention with the features specified in the patent claim eliminates said drawbacks and makes it possible to raise the otherwise low speed for acquiring the original in one processing step to the high speed of the printer, and to avoid falsifications due to dirty optics and/or manual interventions, for example in the form of mix-ups.

The advantages gained with the invention include in particular that for archiving and offering evidence, an identical copy is always produced in the matrix format of the given document without subjecting the printed original to a later treatment, for example by a scanner or through microfilming. Said identical copy can then be used again for producing a printed image that is identical with the original.

The speed of the printer is not impaired either in the acquisition or the printing process.

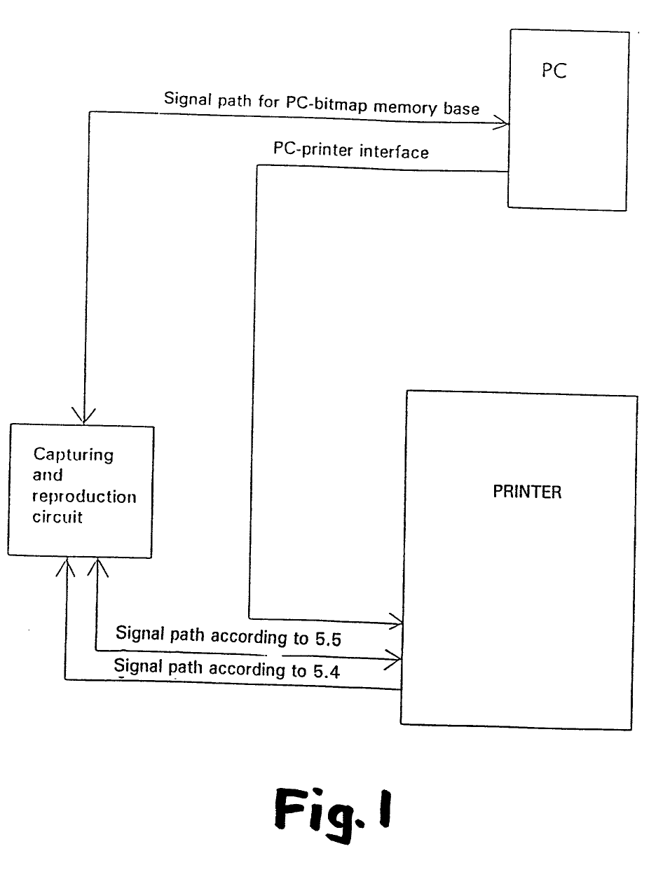

An exemplified embodiment of a Delphax^{(R)} ion jet printer with a speed of up to 150 DIN A4-pages per minute is shown in the drawing in FIG. 1 and described in the following.

The connection designated as “signal according to 5.4” transports the screened bitmap data from the printer to the acquisition and reproduction circuit.

In said circuit, the data are duplicated during printing and, provided with the format information for the current print, transmitted to a circuit in the PC and stored. This takes place via the connection designated as “signal path for PC-bitmap memory”.

Via the connection designated as “signal path according to 5.5”, the screened bitmap data are returned again for printing to the printer.

When the screened bitmap data stored in the PC are to be printed again, this takes place by the reversed process.

Via the connection designated as “signal path for PC-bitmap memory”, the screened bitmap data are received in the acquisition and reproduction circuit and from there passed to the printer via the connection designated as “signal path according to 5.5”.

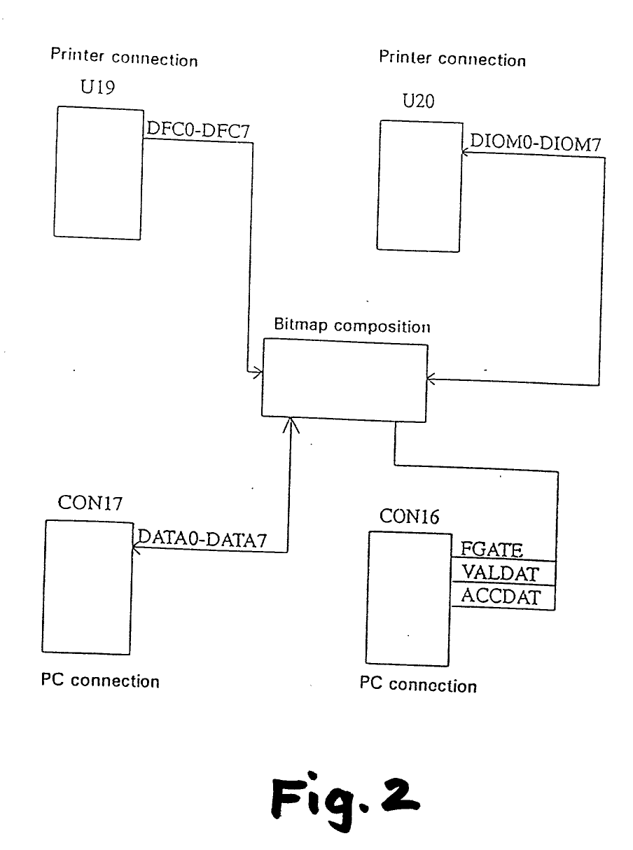

### SIGNAL DESCRIPTION Or ACQUISITION AND REPRODUCTION CIRCUIT ACCORDING TO FIG. 2

The signals applied to the following connections are relevant to the acquisition and reproduction of the printed image:

| | | | |
|---|---|---|---|
| 5.1 | | | |
| Signal name: | Pin: | Plug connector | Application purpose: |
| FCATE | 4 | CON16 | Main cycle for controlling |
| | | | the overall sequence. |
| 5.2 | Pin: | Plug connector | Application purpose: |
| Signal name: | all | CON16 | Bidirectional data bus |
| DATAO-DATA7 | straight | | with color information |
| | pins | | for the matrix dots. |
| 5.3 | | | |
| Signal name: | Pin: | Plug connector | Application purpose: |
| VALDAT | 6 | CON16 | Handshake signal for data |
| | | | traffic out of the printer. |
| ACCDAT | 8 | CON16 | Handshake signal for data |
| | | | traffic into the printer. |
| 5.4 | | | |
| Signal name: | Pin: | Plug connector | Application purpose: |
| DFC0-SCF7 | 1-8 | U19 | Unidirectional data signal |
| | | | coming from the matrix |
| | | | image processor with color |
| | | | information for the matrix |
| | | | dots. |
| 5.5 | | | |
| Signal name: | Pin: | Plug connector | Application purpose: |
| DIOMO-DIOM7 | 1-8 | U20 | Logic operation of data |
| | | | signals ex 5.2 and 5.4. |

The PC is connected to the acquisition and reproduction circuit via connections CON16 and CON17. This connection is designated as “signal path for PC-bitmap memory”.

The printer is connected to the acquisition and reproduction circuit via connections U19 and U20.

Connection U19 to the printer is designated as “signal path according to 5.4”.

Connection U20 to the printer is designated as “signal path according to 5.5”.

1. A method of archiving documents, characterized in that an acquisition and reproduction circuit activates the memory of a personal computer by means of the last printed image-producing output signals of a running printer and stores in said memory a binary identical image of the document to be printed, such image being recorded on a non-erasable data carrier (e.g.) CD-ROM) for permanent storage.

2. The method according to claim 1, characterized in that for copying purposes, the printer is caused to produce a renewed printout, retracing the same data path.

3. The method according to claim 1, characterized in that the archived binary identical image is made visible by displaying it on the screen of the personal computer.
